(19) United States
(12) Patent Application Publication
(10) Pub. No.: US 2014/0085862 A1
(43) Pub. Date: Mar. 27, 2014

(54) LIGHTING DEVICE

(71) Applicant: TOSHIBA LIGHTING & TECHNOLOGY CORPORATION, Kanagawa (JP)

(72) Inventors: Kazunari HIGUCHI, Kanagawa (JP); Masashi Nakayama, Kanagawa (JP); Yusuke Ichijo, Kanagawa (JP); Hiroyuki Kuramochi, Shizuoka (JP); Toru Ebihara, Shizuoka (JP)

(73) Assignee: Toshiba Lighting & Technology Corporation, Kanagawa (JP)

(21) Appl. No.: 13/828,684

(22) Filed: Mar. 14, 2013

(30) Foreign Application Priority Data
Sep. 24, 2012 (JP) 2012-210207

(51) Int. Cl. F21V 7/00; F21V 9/16

(52) U.S. Cl. CPC F21V 7/00; F21V 9/16
USPC 362/84; 362/310

(57) ABSTRACT

According to one embodiment, a lighting device includes a main body, a light source, a light transmitting cover, and a reflector. The main body is formed from metal. The light source has a substrate formed from ceramic and attached to the light source attachment portion of the main body, and a light emitting element mounted on the substrate. The light transmitting cover is formed from glass. The reflector is formed from metal. The reflector is held by the main body without contact with respect to the main body and the light source between the light source attachment portion and the light transmitting cover. Between the light source attachment portion and the light transmitting cover, parts irradiated with light emitted from the light emitting element do not contain resin except a part in the light source.

### CROSS-REFERENCE TO RELATED APPLICATION

This application is based upon and claims the benefit of priority from Japanese Patent Application No. 2012-210207, filed on Sep. 24, 2012; the entire contents of which are incorporated herein by reference.

### FIELD

Embodiments described herein relate generally to a lighting device.

### BACKGROUND

In lighting devices using an LED (Light Emitting Diode) element, over the years output is progressively becoming higher and the heat quantity and luminous flux value are also increasing. In particular, due to the increase in the luminous flux, there is concern of deterioration of resins used in the lighting device due to light absorption.

### BRIEF DESCRIPTION OF THE DRAWINGS

FIG. 1 is a perspective view of a lighting device of a first embodiment.

FIG. 2 is a perspective view of the lighting device.

FIG. 3 is a perspective view of a main body the lighting device.

FIG. 4 is a perspective view of the main body.

FIG. 5 is a plan view of a light source.

FIG. 6 is an expanded perspective view of an attachment structure of the light source with respect to a main body.

FIG. 7 is a schematic cross-sectional view of the lighting device.

FIG. 8 is a bottom view of the main body.

FIG. 9 is a perspective view of an insulating member shown in FIG. 7.

FIG. 10 is a perspective view of the main body.

FIG. 11 is a perspective view of the main body.

FIG. 12 is a perspective view of a holding member of the lighting device.

FIG. 13 is a perspective view of the holding member.

FIG. 14 is a perspective view of a lighting device of a second embodiment.

FIG. 15 is a perspective view of the lighting device.

FIG. 16 is an exploded perspective view of the lighting device.

FIG. 17 is a schematic plan view of a reflector and a light source of the lighting device.

### DETAILED DESCRIPTION

According to one embodiment, a lighting device includes a main body, a light source, a light transmitting cover, and a reflector. The main body is formed from metal. The main body has a light source attachment portion. The light source has a substrate formed from ceramic and attached to the light source attachment portion of the main body, and a light emitting element mounted on the substrate. The light transmitting cover is formed from glass. The light transmitting cover is provided opposed to the light source attachment portion. The reflector is formed from metal. The reflector is held by the main body without contact with respect to the main body and the light source between the light source attachment portion and the light transmitting cover. Between the light source attachment portion and the light transmitting cover, parts irradiated with light emitted from the light emitting element do not contain resin except a part in the light source.

Below, embodiments will be described with reference to the drawings. Moreover, in the drawings, like elements are given the same reference numbers.

### First Embodiment

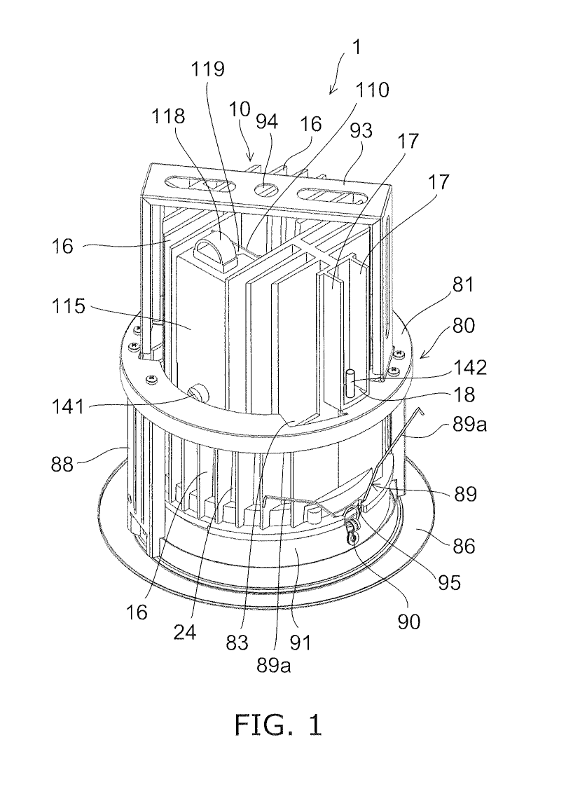

FIG. 1 is a perspective view of lighting device 1 according to a first embodiment.

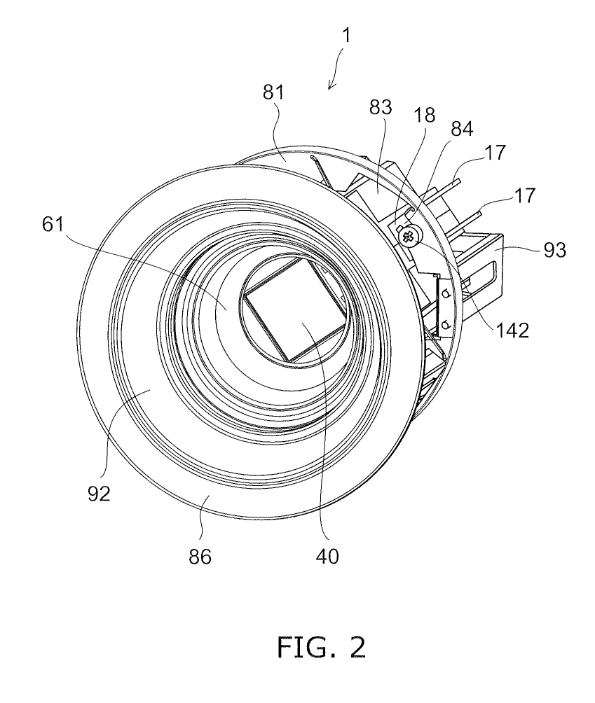

FIG. 2 is a perspective view of the lighting device 1 shown in FIG. 1 seen from the lower side.

The lighting device 1 according to the first embodiment includes a main body 10, a light source 40 provided inside the main body 10, and a holding member 80 holding the main body 10.

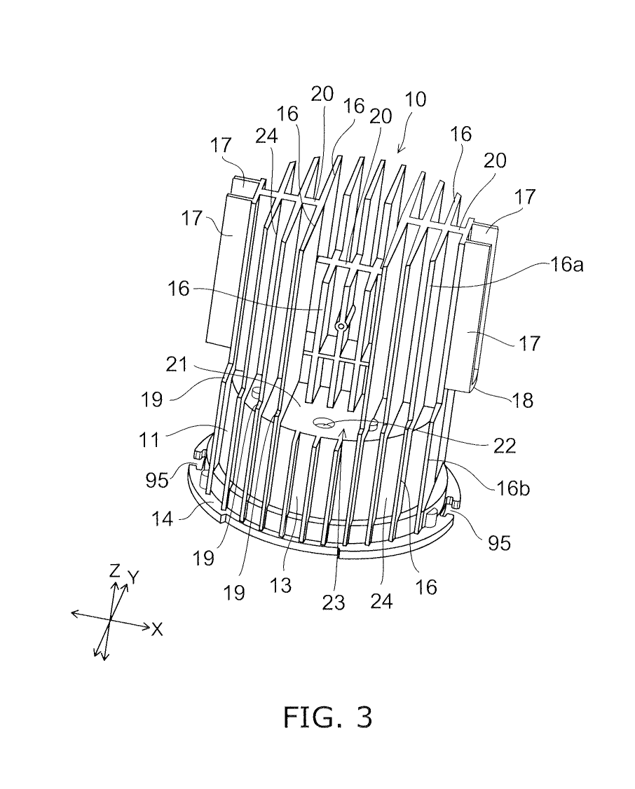

FIG. 3 is a perspective view of the main body 10.

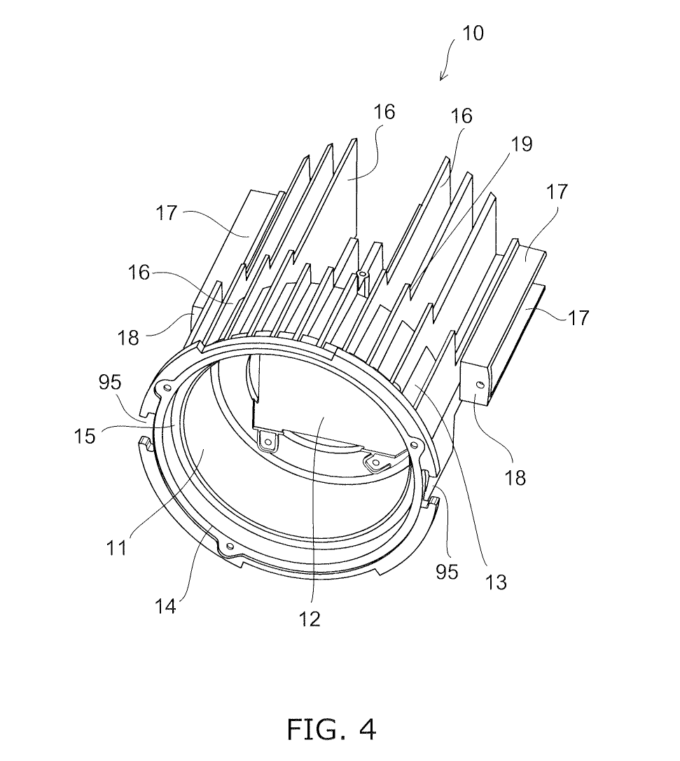

FIG. 4 is a perspective view of the main body 10 seen from the lower side.

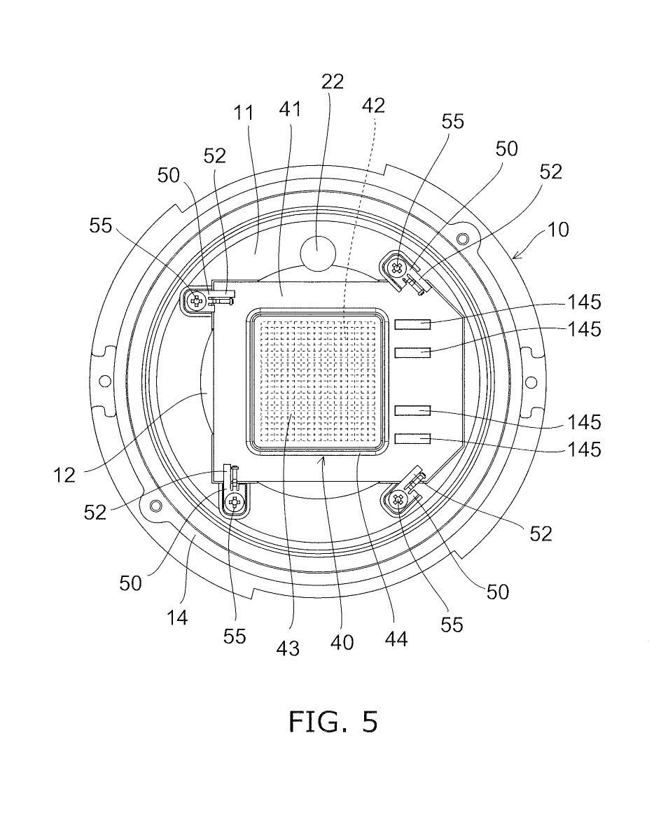

FIG. 5 is a bottom view of the main body 10.

The main body 10 is formed from metal and also serves as a radiator. Moreover, in the present specification, “metal” is not limited to pure metals, and also includes alloys. The main body 10 is, for example, a die-cast aluminum molded body.

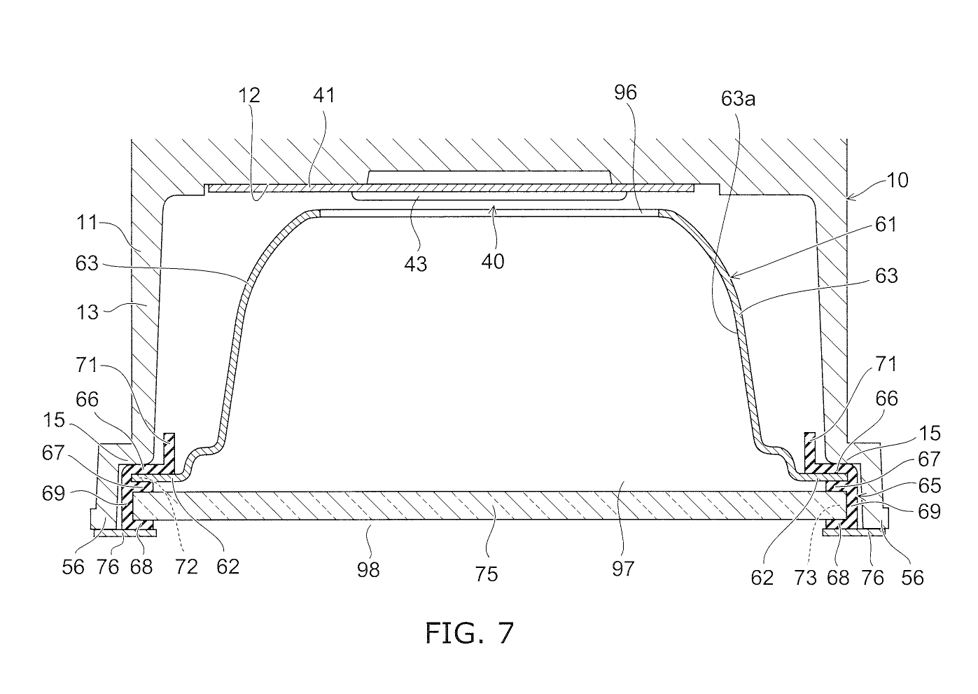

The main body 10 includes a bowl-shaped container-like light source accommodation portion 11. The light source accommodation portion 11 includes a cylindrical sidewall portion 13, and a light source attachment portion 12 provided on the upper end portion of the sidewall portion 13, as shown in FIG. 4. On the lower end side of the sidewall portion 13, an opening 98 (as shown in FIG. 7) opposing the light source attachment portion 12 is formed, and a flange portion 14 is provided on the peripheral edge portion of the opening 98. The sidewall 13 is provided between the light source attachment portion 12 and the edge portion of the opening 98.

A ring-like reflector support 15 is provided on the inside of the sidewall portion 13 nearer to the light source attachment portion 12 than the opening 98. A step difference is formed between the flange portion 14 and the reflector support portion 15.

Plural first fins 16 are provided on the upper face (back surface side of the light source attachment portion 12) of the light source accommodation portion 11 which is the rear surface of the light source attachment portion 12, and on the outer wall of the sidewall portion 13. The first fins 16 extend in the height direction (Z direction in FIG. 3) of the main body 10.

The plural first fins 16 are arranged in the X direction intersecting with respect to the Z direction, and a gap 24 is formed between first fins 16 adjacent in the X direction.

On the upper surface of the light source accommodation portion 11, a partition wall 20 is provided extending in the X direction. The first fins 16 extend in the Y direction intersecting with respect to the Z direction and the X direction with the partition wall 20 interposed.

The first fins 16 are each provided with a step portion 19 partway along the Z direction. The first fins 16 include a lower portion 16b provided on the outer wall of the sidewall portion 13 of the light source accommodation portion 11 and an upper portion 16a provided on the upper surface of the light source accommodation portion 11. The step portion 19 is provided between the upper portion 16a and the lower portion 16b of the first fins 16. The lower portion 16b protrudes further to the outside in the Y direction than the upper portion 16a. Seen from above the main body 10, the plural step portions 19 are arranged on a path drawing a circle.

A second fin 17 is provided on the outer wall of the first fin 16 provided on the outermost side in the X direction. Two second fins 17 are provided spaced apart in the Y direction at one end portion in the X direction of the partition wall 20, and further two second fins 17 are provided spaced apart in the Y direction also at the other end in the X direction of the partition wall 20.

The second fins 17 extend upward from the step portions 19, and do not extend downward from the step portions 19. Accordingly, the length of the second fins 17 in the Z direction is shorter than the length of the first fins 16 in the Z direction.

A screw fixing portion 18 is provided between the lower end portions of the two second fins 17 adjacent in the Y direction, as shown in FIG. 1 and FIG. 4. The second fins 17 and screw fastening portion 18 protrude to the outside in the X direction from the sidewall of the first fin 16 on the outermost side in the X direction.

A light source 40 as shown in FIG. 5 is attached to the light source attachment portion 12 of the main body 10 shown in FIG. 4.

The light source 40 includes a substrate 41 formed from ceramic and plural light emitting elements 42 mounted on the substrate 41. The light emitting element 42 is, for example, an LED (Light Emitting Diode) element.

As the material of the active layer of the LED, for example, if a gallium nitride (GaN) based compound semiconductor is used, short wavelength light with a wavelength of 500 nm or less is obtained. However, the material of the active layer is not limited to a gallium nitride based compound semiconductor.

In addition, as the light emitting element 42, in addition to an LED, for example, an organic light emitting diode (OLED), inorganic electroluminescence light emitting element, organic electro luminescence light emitting element, or other electroluminescence type light emitting element or the like may be used.

The surface of the light emitting element 42 is covered by a phosphor layer 43. The phosphor layer 43 includes a resin layer and plural particle-like phosphors dispersed in the resin layer.

The periphery of the mounting region of the light emitting element 42 is surrounded by a resin 44, such as, for example, silicone, and the phosphor layer 43 is supplied to the region surrounded by the resin 44. The phosphor layer 43 is thermally cured after being supplied in a liquid state. The spreading of the liquid phosphor layer 43 is regulated by the resin 44.

In the embodiment, for example, the light source 40 emits white or light bulb color light as a mixed color of blue light and yellow light through a combination of a light emitting element (LED) 42 emitting blue light and the phosphor layer 43 including a phosphor converting to yellow light by absorbing the blue light (excitation light). Moreover, a phosphor including a red phosphor emitting red light and a green phosphor emitting a green light may be used.

The substrate 41 of the light source 40 is fixed with respect to the light source attachment portion 12 of the main body 10 by metal spring members 50. As shown in FIG. 5, for example, the vicinities of the four corners of the substrate 41 are fixed with respect to the light source attachment portion 12 by metal spring members 50.

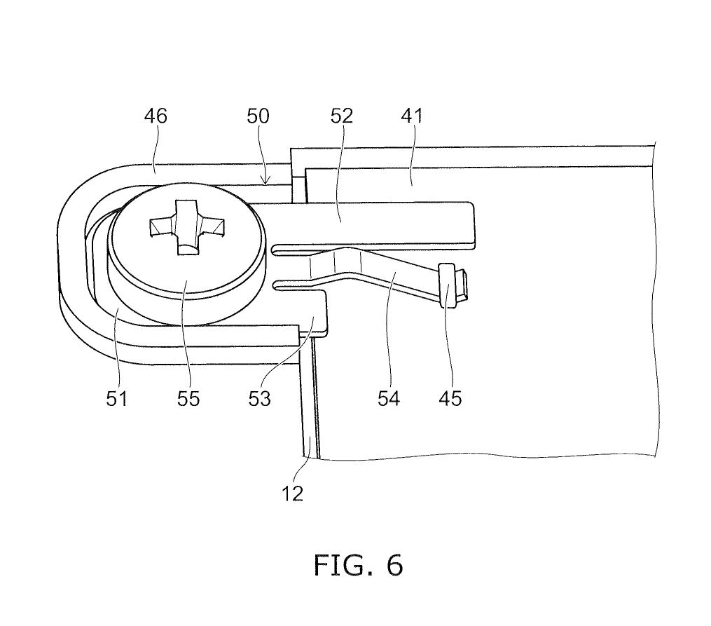

In FIG. 6, an expanded perspective view of the attachment portion of the substrate 41 with respect to the light source attachment portion 12 using the metal spring member 50 is shown.

The metal spring member 50 is formed as a metal plate integrally provided with a screw fastening portion 51, a pair of projection portions 52 and 53 projecting from the screw fastening portion 51, and a plate spring 54 projected from the screw fastening portion 51 between the pair of projection portions 52 and 53.

On the light source attachment portion 12, a U-shaped rib 46 with a flat-planar shape is provided, and the screw fastening portion 51 is accommodated inside the rib 46. The screw fastening portion 51 is fixed with respect to the light source attachment portion 12 by a screw 55. The rib 46 has a function of a stopper for the screw fastening portion 51.

The protrusion length of the one protrusion portion 53 of the pair of protrusion portions 52 and 53 is shorter than the protrusion length of the other protrusion portion 52. As shown in FIG. 5, of the pair of protrusion portions 52 and 53, at least the protrusion portion 52 with the longer protrusion length extends to a position overlapping the substrate 41.

The plate spring portion 54 is a plate spring supported as a cantilever by the screw fastening portion 51, and pushes the substrate 41 against the light source attachment portion 12 using the biasing force (elastic recovery force) thereof. The tip end of the plate spring portion 54 is hooked into an engagement portion 45 provided on the substrate 41, and fluctuations in position of the pressing portion of the plate spring portion 54 with respect to the substrate 41 are regulated.

Because the one protrusion portion 53 of the pair of protrusion portions 52 and 53 is shorter than the other protrusion portion 52, the workability taking the plate spring portion 54 by a finger or tool and inserting and hooking the tip portion thereof into the engagement portion 45 is good.

FIG. 7 is a schematic cross-sectional view of the inside of the light source accommodation portion 11 of the main body 10.

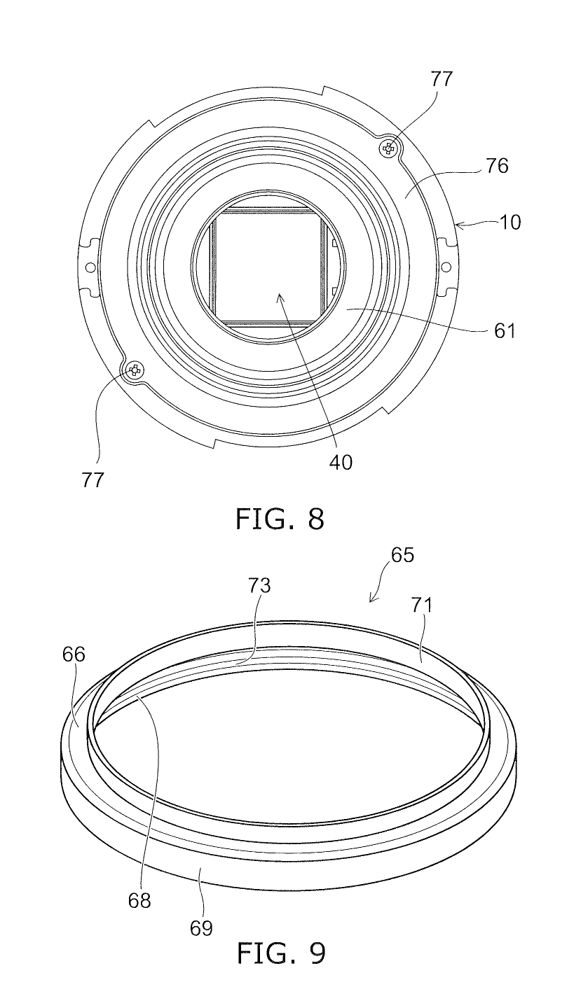

FIG. 8 is a bottom view of the light source 40 seen from the light transmitting cover 75 side in FIG. 7.

The light emitting surface of the light source 40 (surface to which the light emitting element 42 is mounted, or the surface of the phosphor layer 43) faces the space surrounded by the sidewall portion 13 of the light source accommodation portion 11. A reflector 61 is provided in the space.

The reflector 61 is formed from metal. The reflector 61 is formed from aluminum to which glossiness is imparted by being alumite treated (oxide film treatment) after the surface is buffed, for example.

The reflector 61 includes a ring-shaped flange portion 62, and a cylindrical portion 63 protruded toward the light source 40 side from the edge portion of the inner side of the flange portion 62.

The tip of the cylindrical portion 63 (upper end in FIG. 7) protrudes up to the vicinity of the light emitting surface (region where the light emitting element 42 and phosphor layer 43 are provided) of the light source 40, and the light emitting surface of the light source 40 faces the space on the inside of the cylindrical portion 63 of the reflector 61. The cylindrical portion 63 is separated from the light source 40, and is not in contact with the light source 40.

A light opening 96 is formed in the light source 40 side of the cylindrical portion 63, and floodlight opening 97 is formed on the flange portion 62 side of the cylindrical portion 63. The light opening 96 faces toward the light emitting surface of the light source 40, and the floodlight opening 97 faces toward the opening 98 of the lower end of the main body 10 via the light transmitting cover 75.

The light opening 96 and the floodlight opening 97 are formed in a circular or close to circular shape with the respective centers thereof matched, and the area of the light opening 96 is smaller than the area of the floodlight opening 97. The cylindrical portion 63 expands and opens towards the floodlight opening 97 from the light opening 96, and a reflecting surface 63a is formed on the inner wall surface thereof.

A light transmitting cover 75 is provided on the opening 98 side of the main body 10, below the reflector 61. The light transmitting cover 75 is formed from glass and has permeability with respect to light emitted from the light source 40. The light transmitting cover 75 is formed in a circular plate shape, and is separated with respect to the reflector 61 below the reflector 61, and covers the interior space of the light source accommodation portion 13.

The reflector 61 and the light transmitting cover 75 are both supported by a shared (one) insulating member 65, and are attached with respect to the main body 10.

FIG. 9 is a perspective view of the insulating member 65.

The insulating member 65 is formed from a resin or rubber material softer than the metal of the reflector 61 and the glass of the light transmitting cover 75, and has electrical insulation properties. For example, the insulating member 65 is formed from a material including silicone as a main component.

The insulating member 65 is interposed between the flange portion 62 of the reflector 61 and the outer edge portion of the light transmitting cover 75, and between the flange portion 62 of the reflector 61 and a reflector support portion 15 of the main body 10, and holds the flange portion 62 of the reflector 61 and the outer edge of the light transmitting cover 75.

The insulating member 65 includes a first ring portion 66 interposed between the reflector support portion 15 of the main body 10 and the flange portion 62 of the reflector 61. Furthermore, the insulating member 65 includes a second ring portion 67 interposed between the flange portion 62 of the reflector 61 and the outer edge portion of the light transmitting cover 75. Furthermore, the insulating member 65 includes a third ring portion 68 covering the outer edge portion of the light transmitting cover 75 on the opposite side of the second ring portion 67. Furthermore, the insulating member 65 includes a side surface portion 69 interposed between the side surface of the flange portion 62 of the reflector 61 and the inner wall of the light source accommodation portion 11, and between the side surface of the light transmitting cover 75 and the inner wall of the light source accommodation portion 11.

An annular first groove 72 is formed between the first ring portion 66 and the second ring portion 67, and the flange portion 62 of the reflector 61 is inserted into the first groove 72.

An annular second groove 73 is formed between the second ring portion 67 and the third ring portion 68, and the outer edge portion of the light transmitting cover 75 is inserted into the second groove 73.

The second groove 73 is formed below the first groove 72 with the second ring portion 67 interposed. The outer edge portion of the light transmitting cover 75 overlaps below the flange portion 62 of the reflector 61, with the second ring portion 67 interposed. The light transmitting cover 75 is separated with respect to the flange portion 62 of the reflector 61, and is not in contact with therewith.

A ring-shaped pushing member 76 overlaps with the third ring portion 68 of the insulating member 65 and the lower end portion 56 of the main body 10. The pushing member 76 is formed from metal, and is fastened by screwing to the lower end portion 56 of the main body 10 by a screw 77 shown in FIG. 8.

As shown in FIG. 7, the insulating member 65, and the reflector 61 and light transmitting cover 75 held by the insulating member 65 are held with respect to the main body 10, and are interposed between the pushing portion 76 and the reflector support portion 15 of the main body 10.

The insulating member 65 is interposed between the flange portion 62 of the reflector 61 and the main body 10, and the flange portion 62 of the reflector 61 is not in contact with the main body 10. In addition, the cylindrical portion 63 of the reflector 61 is separated from main body 10, and is not in contact therewith.

The main body 10 formed from metal is grounded. The reflector 61 is electrically floating without being in contact with the main body 10 and the light source 40.

The light reflecting function is mainly borne by the cylindrical portion 63 of the reflector 61. Meanwhile, since the flange portion 62 of the reflector 61 is a part supported with respect to the main body 10, the distance to the main body 10 becomes shorter compared to the cylindrical portion 63.

According to the embodiment, while realizing high reliability through configuring the reflector 61 from metal which has superior durability than a resin, rather than resin for which there is concern of deterioration due to light absorption, by interposing the insulating member 65 between the flange portion 62 of the reflector 61 and the main body 10, a sufficient creepage distance (shortest distance along an insulator surface between two conductive parts) may be ensured between the flange portion 62 of the reflector 61 and the main body 10.

In addition, by the light transmitting cover 75 using glass rather than resin, defects due to resin deterioration may be avoided. There is concern of breakage of the glass light transmitting cover 75 with direct contact with respect to the metal reflector 61; however, according to the embodiment, the glass light transmitting cover 75 is protected by interposing the insulating member 65 between the flange portion 62 of the reflector 61 and the light transmitting cover 75.

Increases in the number of components may be suppressed by the use of one insulating member 65 both for protection of the glass light transmitting cover 75 and for insulation of the reflector 61 and main body 10. As a result, cost reductions can be achieved. Furthermore, with respect to the main body 10, the assembling characteristics of assembling the insulating member 65, the reflector 61 and the light transmitting cover 75 may be improved.

In addition, according to the embodiment, as shown in FIG. 7, the insulating member 65 further includes an extension portion 71 protruding to the light source 40 side from the first ring portion 66. The extension portion 71 is formed in a ring-shape or cylindrical shape surrounding the periphery of the cylindrical portion 63 of the reflector 61 and interposed between the side wall portion 13 of the main body 10 and the cylindrical portion 63 of the reflector 61.

In the cylindrical portion 63 of the reflector 61, the distance to the side wall portion 13 of the main body 10 is shorter in the lower portion close to the flange portion 62 than in the upper portion of the light source 40 side. By interposing the extension portion 71 of the insulating member 65 between the lower portion of the cylindrical portion 63 and the main body 10, the creepage distance between the lower portion of the cylindrical portion 63 and the main body 10 may be sufficiently ensured.

The extension portion 71 of the insulating portion 65 is separated from the cylindrical portion 63 of the reflector 61, and is not in close contact with the cylindrical portion 63. Therefore, an insulating member 65 is generally used for a reflector 61 having various sizes and shapes of cylindrical portion 63.

In addition, the extension portion 71 of the insulating member 65 is separated from the inner wall of the main body 10, and is not in contact with the inner wall of the main body 10. Therefore, when inserting the ring-shaped insulating member 65 in the main body 10, lowering of the insertion workability by the extension portion 71 hitting the inner wall of the main body 10 is avoided.

A part of the light emitted from the light emitting element 42 is irradiated on the substrate 41 after returning to the light source 40 side by reflecting on the reflector 61 and the light transmitting cover 75. The reflected light illuminating the substrate 41 is directed toward the light transmitting cover 75 by again reflecting on the substrate 41. Accordingly, in the space between the light source 40 and the light transmitting cover 75, the reflector 61, the light transmitting cover 75 and the substrate 41 receive the irradiation of light. According to the embodiment, the reflector 61 is metal, the light transmitting cover 75 is glass, and neither includes resin.

In addition, the substrate 41 of the light source 40 is ceramic, and the substrate 41 is attached to the light source attachment portion 12 of the metal main body 10 by the screw 55 and the spring member 50 both of which are metal, as shown in FIG. 5. Furthermore, metal wiring patterns are formed on the substrate 41, and the light emitting element 42 is connected through the wiring patterns to connectors 145 mounted on the substrate 41. The connectors 145 are formed from a metal. Since the substrate 41 is formed from an insulating ceramic, the wiring patterns formed on the substrate 41 do not short circuit themselves through the substrate 41.

In other words, the part between light emitting surface of the light source 40 and the light transmitting cover 75 irradiated with light does not contain resin, except for the phosphor layer 43 of the light source 40 and the resin 44 on the periphery thereof. Currently, the use of resin is suppressed to the minimum element necessary in which there is no choice but to use resin.

Accordingly, deterioration due to temperature rises or irradiation of light of the part between light emitting surface of the light source 40 and the light transmitting cover 75 irradiated with light may be suppressed, and lighting device 1 with high reliability may be provided.

As shown in FIG. 3, on the upper surface of the light source accommodation portion 11 of the main body 10, a connector attachment space 23, which is formed by making the projection length in the Y direction of a part of the first fins 16 shorter than that of the other first fins 16, is provided.

At both ends in the X direction of the connector attachment space 23, the first fins 16 are positioned so as to partition the connector attachment space 23. These first fins 16 are positioned interposing the connector attachment space 23 in the X direction. A through hole 22 is formed in the bottom surface 21 (upper surface of the light source accommodation portion 11) of the connector attachment space 23.

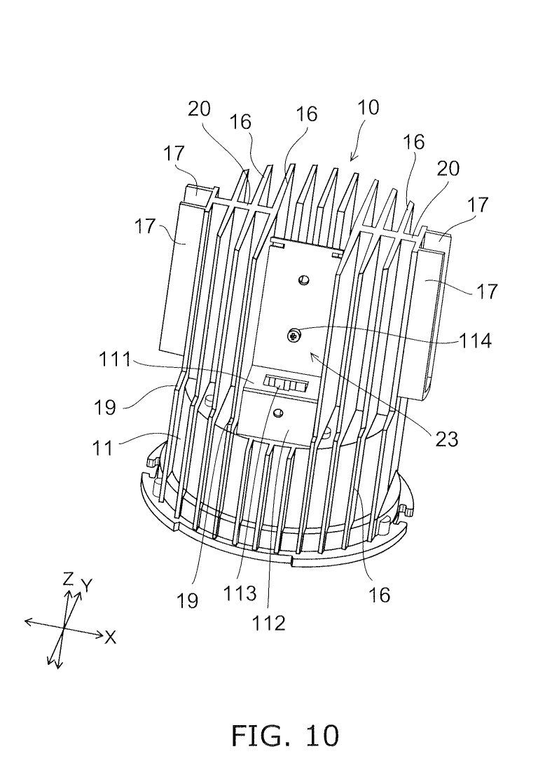

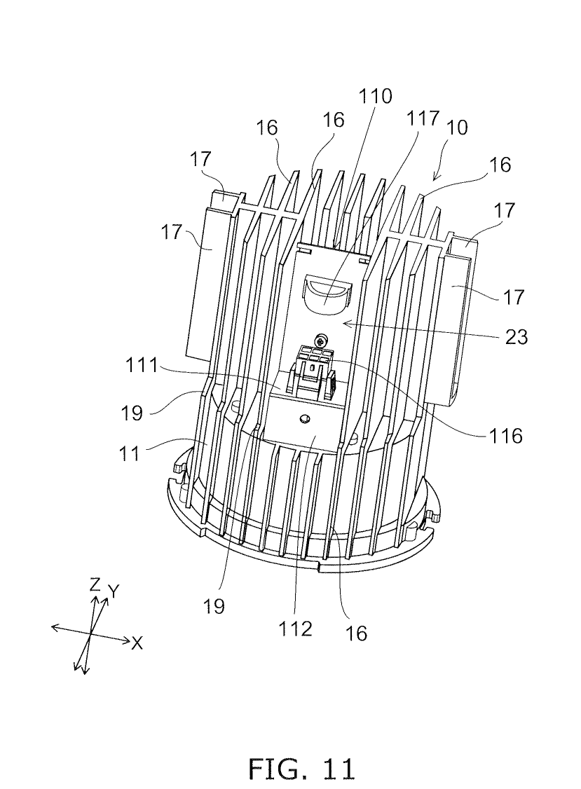

A connector fixing bracket 110 is provided in the connector attachment space 23, as shown in FIGS. 10 and 11. The connector fixing bracket 110 is screw fastened to the first fin 16 by a screw 114.

The space of the bottom surface side in the connector attachment space 23 is surrounded by a side plate 112 of the connector fixing bracket 110 and a connector support plate 111. An opening 113 is formed in the connector support plate 111.

A connector (or terminal block) 116 is provided on the connector support plate 111, as shown in FIG. 11. The connector 116 is electrically connected to the connectors 145 of the light source 40 provided on the light source attachment portion 12 shown in FIG. 5 at the rear side of the upper surface of the light source accommodation portion 11 by a wiring cable passing through the opening 113 formed in the connector support plate 111 and the through hole 22 formed in the upper surface of the light source accommodation portion 11.

A wiring insertion port of the connector 116 faces upward in the height direction (Z direction) of the main body 10. In addition, a cable guide 117 is attached to the connector fixing bracket 110.

A wiring cable connected to a lighting unit separately provided to the lighting device 1 passes from above to below through a cable guide 117 and is plugged into the wiring insertion port of the connector 116 below the cable guide 117 as is. Via the connector 116, the lighting unit and light source 40 are electrically connected, and the output of the lighting unit is sent to the light source 40.

After connecting of the wiring cable of the lighting unit to the connector 116, the connector attachment space 23 is covered with a connector cover 115 shown in FIG. 1. The connector cover 115 is screw fastened to the side plate portion 112 of the connector fixing bracket 110 by a screw 141. The connection portion of the connector 116 and the wiring cable is protected from dust and the like by the connector cover 115.

The wiring cable connected to the connector 116 on the inside of the connector attachment space 23 on the inner side of the connector cover 115 is guided to the outside of the connector attachment space 23 through a notch 119 formed between the connector cover 115 and the connector fixing bracket 110, passes through a cable guide 118 further provided on the upper surface of the connector cover 115 and is connected to the lighting unit.

As shown in FIG. 11, the wiring insertion port of the connector 116 faces upward, and the wiring cable extends in the height direction of the main body 10 and is extracted upwards from the main body 10 through further guiding by the cable guide 117. In addition, the connector fixing bracket 110 and the connector 116 attached to the connector fixing bracket 110 are provided in the space 23 between first fins 16, and do not protrude further in the Y direction than the first fins 16.

Therefore, when passing the main body 10 through the main body attachment ring 81 described later, the connector 116 and the wiring cable do not interfere, and the assembling workability is excellent.

Next, the holding member 80 will be described.

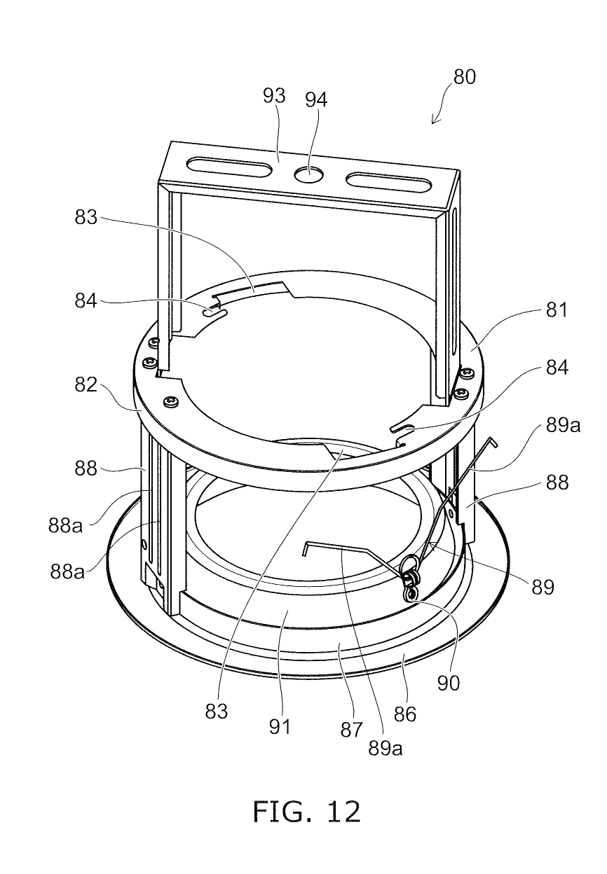

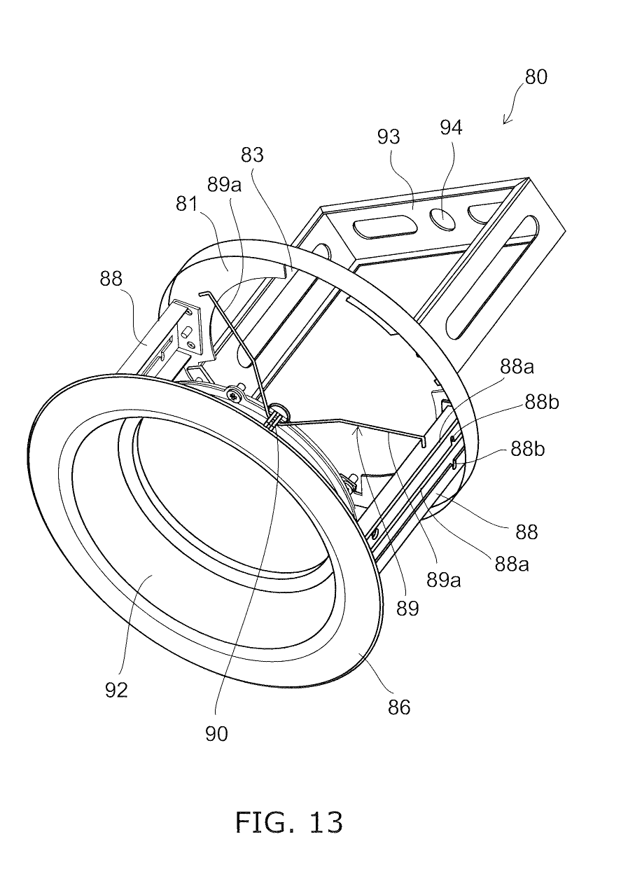

FIGS. 12 and 13 are perspective views of the holding member 80.

The holding member 80 includes a main body attachment ring (hereinafter, referred to simply as an attachment ring) 81 to which the main body 10 described above is attached.

On the edge portion of the outer circumferential side of the attachment ring 81, a rib 82 projecting downwards is provided continuously along the circumferential direction of the attachment ring 81. The rib 82 enhances the strength of the attachment ring 81.

A pair of notches 83 opening on the inner circumferential side are formed in the attachment ring 81. The pair of notches 83 are formed at positions interposing the center of the attachment ring 81 in the diameter direction. In each of the notches 83, a U-shaped groove 84 connected continuously to the notch 83 is formed in the circumferential direction at one end portion of the attachment ring 81 in the circumferential direction.

An angle member 93 is provided above the attachment ring 81. The lower end portion of the angle member 93 is screw fastened to the attachment ring 81.

A ring-shaped decorative frame 86 is provided below the attachment ring 81. The decorative frame 86 includes a cylindrical portion 87 projected to the attachment ring 81 side from the edge portion of the inner circumferential side.

The attachment ring 81 and the decorative frame 86 are linked by two chassis 88. The two chassis 88 are provided at positions interposing the center of the attachment ring 81 in the diameter direction and at positions interposing the center of the decorative frame 86 in the diameter direction. The attachment ring 81 and the decorative frame 86 are vertically spaced apart and overlap with the respective centers thereof matched.

The upper end portion of the chassis 88 is screw fastened to the lower surface of the attachment ring 81. The lower end portion of the chassis 88 is screw fastened to the cylindrical portion 87 of the decorative frame 86.

A cylindrical reflecting mirror 92 is attached to the inner side of the decorative frame 86. A part of the upper end portion side of the reflecting mirror 92 projects upwards (toward the attachment ring 81 side) from the cylindrical portion 86 of the decorative frame 86, and a cylindrical attachment bracket 91 is attached to the outer circumferential surface of the projection portion of the reflecting mirror 92. The reflecting mirror 92 and the attachment bracket 91 are freely attachable and detachable without being fixed with respect to the decorative frame 86 and the chassis 88.

A pair of couplings 90 are screw fastened to the outer wall of the attachment bracket 91, and a V-shaped spring 89 is joined to each of the couplings 90. The pair of V-shaped springs 89 are provided at positions interposing the center of the decorative frame 86 in the diameter direction.

Next, the method of attaching the main body 10 with respect to the holding member 80 will be explained.

The main body 10 is relatively moved with respect to the holding member 80 in the axial direction of the attachment ring 81, and passes through the inner side of the attachment ring 81. The main body 10 is inserted into the inside of the decorative frame 86 and the inside of the reflecting mirror 92 from the upper end side of the fins 16 and 17.

The main body 10 passes through the inside of the attachment ring 81 and the second fins 17 is moved upward from the attachment ring 81, in a state where the second fins 17 are positioned in the notches 83 of the attachment ring 81.

The upward movement with respect to the attachment ring 81 of the main body 10 passing through the inside of the attachment ring 81 from the lower surface side of the attachment ring 81 is regulated by the step portions 19 formed partway along the first fins 16 in the height direction hitting the lower surface of the attachment ring 81. Therefore, the main body 10 may be reliably positioned with respect to the holding member 80.

In addition, by using the step portions 19 formed in the first fins 16, a separate component may not be used in positioning of the main body 10 with respect to the holding member 80, and cost reductions by reducing the number of components and simplification of the structure may be achieved.

When the second fins 17 are moved upward from the attachment ring 81, the main body 10 and the attachment ring 81 are relatively rotated in the circumferential direction of the attachment ring 81, and the screw fastening portions 18 of the lower ends of the second fins 17 are moved to the support positions on the attachment ring 81 separated from the notches 83.

Specifically, the screw fastening portion 18 of the second fin 17 is moved to a position formed by the U-shaped groove 84 from the notch 83 on the attachment ring 81. The second fin 17 is supported on the peripheral parts of the U-shaped groove 84 in the attachment ring 81, and extends upward from the attachment ring 81.

Next, the lower end portion 18 of the second fin 17 is fixed by screw fastening with respect to the attachment ring 81. The screw 142 shown in FIGS. 1 and 2 passes through the U-shaped groove 84 of the attachment ring 81 from the lower surface side of the attachment ring 81 and is joined to a screw hole formed in the screw fastening portion 18 of the second fin 17. The shaft portion of the screw 142 project into the space between the second fins 17 as shown in FIG. 1. A washer is interposed between the head portion of the screw 142 and the lower surface of the attachment ring 81.

The pushing member 76 shown in FIGS. 7 and 8 and screw fastened to the lower end portion of the main body 10 faces the upper end of the reflecting mirror 92 of the holding member 80 and the upper end of the attachment bracket 91 with a slight gap. The light transmitting cover 75 approaches the space on the inside of the reflecting mirror 92 above the upper end of the reflecting mirror 92.

Light irradiated from the light source 40 is controlled for light distribution by the reflector 61, the light transmitting cover 75 and the reflecting mirror 92, and is emitted to the outside below the decorative frame 86.

According to the embodiment, the second fins 17 bearing a heat radiating function also bear a function of fixing the main body 10 to the attachment ring 81. Therefore, design is performed with good efficiency leaving out waste, and size reductions, weight reductions and cost reductions are achieved through reduction of the number of components.

The first fins 16 which are longer in the height direction (Z direction) than the second fins 17 extend upward and downward from the attachment ring 81. Between the plural first fins 16, a gap 24 continuous from below to above the attachment ring 81 is formed. Accordingly, the function as a heat radiator of the main body 10 is sufficiently exhibited, without the attachment ring 81 interfering with the convection flow of air along the Z direction of the first fins 16.

The holding member 80 holding the main body 10 may be attached to a lighting device attachment target, such as a ceiling, via, for example, the angle member 93. A bolt suspended from the ceiling passes through the through hole 94 of the angle member 93, and a nut is joined to the bolt projected from the lower surface of the angle member 93.

As shown in FIG. 13, two slits 88a are formed in the chassis 88. The two slits 88a extend in the joining direction of the attachment ring 81 and the decorative frame 86. A U-shaped groove 88b projected in the width direction of the slit 88a is formed in the attachment ring 81 side in the slit 88a. The U-shaped groove 88b formed in one slit 88a of the two slits 88a projects in the direction separating from the other slit 88a.

An attachment bracket not shown in the drawing is plugged in the slit 88a to be freely movable vertically, and the upward movement of the attachment bracket is regulated by the attachment bracket hooking the U-shaped groove 88b. The lighting device 1 is held with respect to the ceiling by the attachment bracket for which the upward movement is regulated pushing the ceiling.

A pair of arms 89a of the V-shaped spring 89 are contracting in the direction approaching each other, and mate with a notch 95 formed in the flange portion 14 of the lower end of the main body 10 shown in FIG. 3.

In FIG. 1, the arms 89a of the V-shaped spring 89 are shown in a state fitted to the notch 95 of the main body 10. After fitting the arms 89a to the notch 95, when force by which the arms 89a are contracted is released, the pair of arms 89a spread due to the elastic recovery force.

Accompanying the movement of the pair of arms 89a spreading, the V-shaped spring 89 moves upward with respect to the main body 10, and the vicinity of the base of the arms 89a fits to the notch 95. In other words, the force spreading the arms 89a becomes a force pushing the V-shaped spring 89 upwards with respect to the main body 10, and the reflecting mirror 92 linked to the V-shaped spring 89 is fitted into the inside of the decorative frame 86. Via the V-shaped spring 89, the attachment bracket 91 and the reflecting mirror 92 attached to the attachment bracket 91 are supported with respect to the main body 10.

The attachment ring 81 is positioned at nearly the middle in the height direction of the main body 10, and because the V-shaped spring 89 is exposed below the attachment ring 81, the attachment ring 81 does not interfere with the operation of the V-shaped spring 89.

### Second Embodiment

Next, a second embodiment of the lighting device 150 will be described.

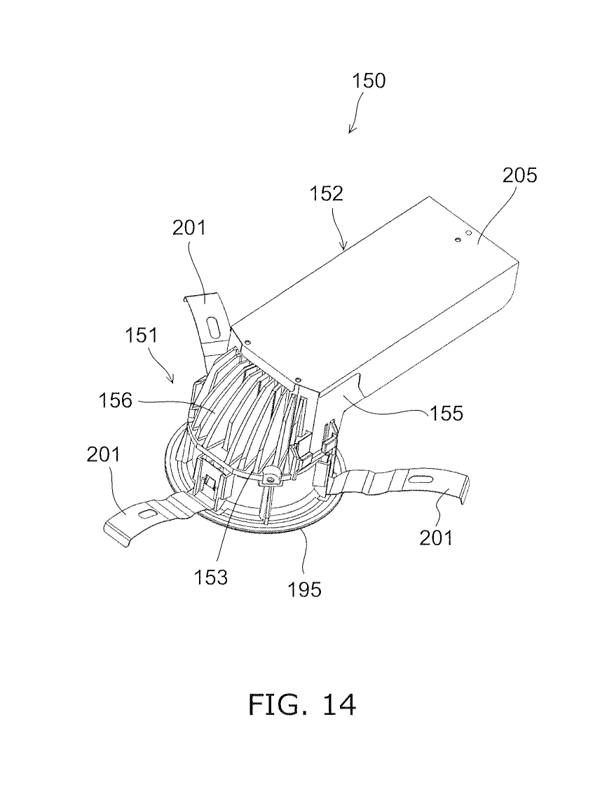

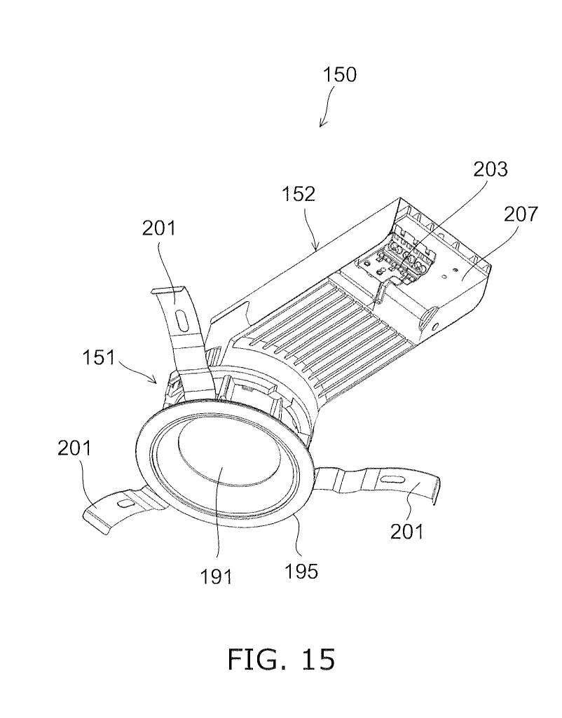

FIGS. 14 and 15 are perspective views of a lighting device 150 of the second embodiment.

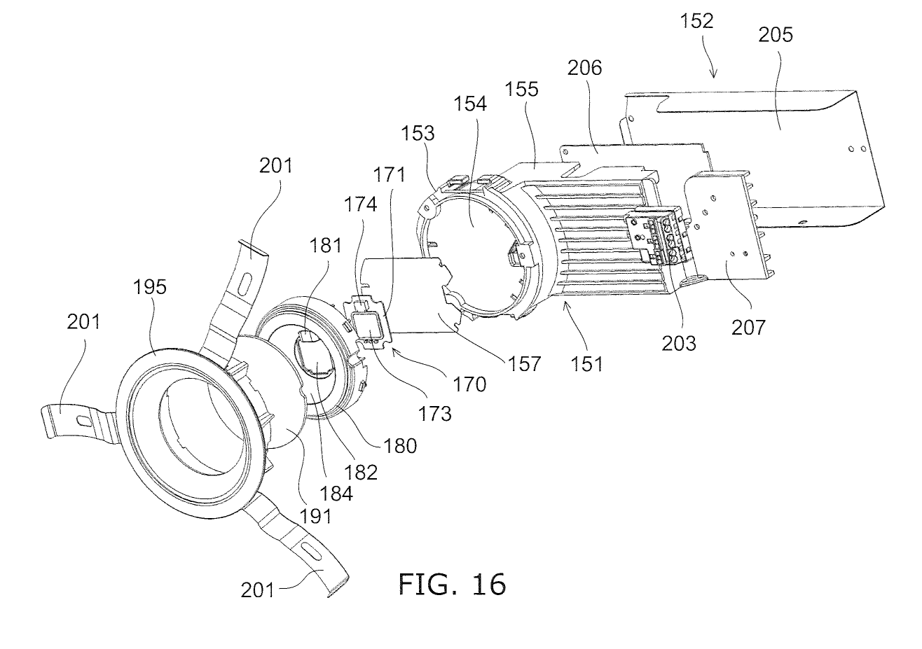

FIG. 16 is an exploded perspective view of a lighting device 150 of the second embodiment.

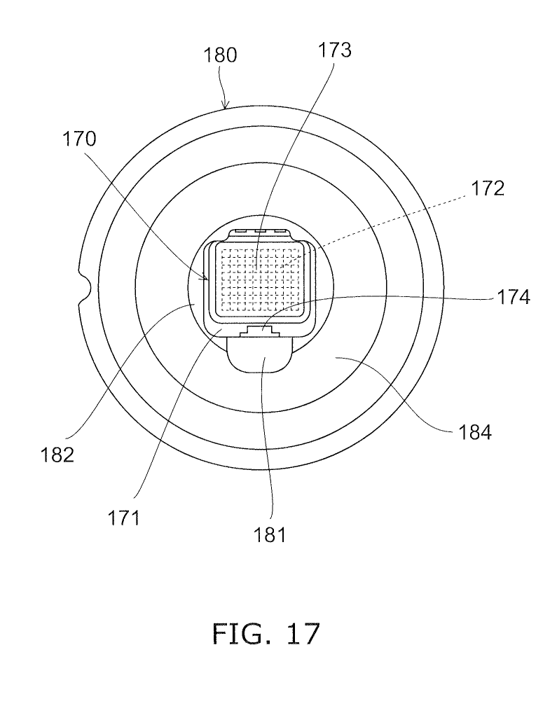

FIG. 17 is a schematic plan view of a light source 170 and a reflector 180.

The lighting device 150 according to the embodiment is a down light attached to a recessed hole formed in a ceiling in a state in which a lighting device main body 151 and a lighting unit 152 are integrated.

The lighting device main body 151 includes a light source accommodation portion 153, and a lighting unit attachment portion 155 provided to be extended from the light source accommodation portion 153 in a direction intersecting with respect to the optical axis of the light source 170.

A light source attachment portion 154 is provided on the lower surface of the light source attachment portion 153. Plural fins 156 are provided at the upper portion of the light source accommodation portion 153, and the light source accommodation portion 153 functions as a heat radiator radiating heat of the light source 170.

The light source 170 is attached with respect to the light source accommodation portion 154 via an attachment plate 157. The light source 170 includes a substrate 171 and plural light emitting elements 172 mounted on the substrate 171. The light emitting element 172 is, for example, an LED element.

In addition, as the light emitting element 172, in addition to an LED, for example, an organic light emitting diode (OLED), inorganic electroluminescence light emitting element, organic electro luminescence light emitting element, or other electroluminescence type light emitting element or the like may be used.

The surface of the light emitting element 172 is covered by a phosphor layer 173. The phosphor layer 173 includes a resin layer and plural particle-like phosphors dispersed in the resin layer. The resin layer of the phosphor layer 173 is transparent with respect to emission light (excitation light) of the light emitting element 172 and fluorescence emission of the phosphor.

For example, the light source 170 emits white or light bulb color light as a mixed color of blue light and yellow light through a combination of a light emitting element (LED) 172 emitting blue light, the phosphor layer 173 including a phosphor converting the blue light (excitation light) absorbed to yellow light. Moreover, a phosphor including a red phosphor emitting red light and a green phosphor emitting a green light may be used.

A connector 174 is mounted to the outside of the mounting region of the light emitting element 172 on the substrate 171. A wiring pattern not shown in the figure is formed on the substrate 171, and the light emitting element 172 and the connector 174 are electrically connected through the wiring pattern.

For the light source 170, the light emitting surface (surface of the phosphor layer 173) thereof faces the opposite side of the light source attachment portion 154.

A reflector 180 is provided at the light source attachment portion 154 side in the light source accommodation portion 153. The reflector 180 is formed from a resin material, and the surface of the reflector 180 is formed, for example, in white, and has reflectivity with respect to light emitted from the light source 170.

The reflector 180 is formed in a ring shape, and the light emitting surface including the light emitting element 172 of the light source 170 and the phosphor layer 173 is exposed to the center hole 182 thereof. Most of the region outside the mounting region of the light emitting element 172 in the substrate 171 of the light source 170 is covered and hidden by the reflector 180.

In addition, a connector shielding portion 181 is provided in a part of the inner peripheral portion of the center hole 182 of the reflector 180. For the connector 174, by only exposing a part of the mounting region side of the light emitting element 172 from the center hole 182 of the reflector 180, the majority of the connector 174 is covered and hidden by the connector shielding portion 181 of the reflector 180. So that the light emitted spreading obliquely from the light emitting surface is not shielded, a part of the light emitting surface side in the connector 174 is set to not shield.

The center hole 182 of the reflector 180 is positioned at the light source 170 side and functions as a light opening. On the opposite side of the light opening of the reflector 180, a floodlight opening with a larger area than the light opening is formed. The reflector 180 expands and opens toward the floodlight opening from the light opening, and a reflecting surface 184 is formed on the inner wall surface thereof.

The floodlight opening of the reflector 180 is covered with a light transmitting cover 191. The light transmitting cover 191 has permeability with respect to light emitted from the light source 170. In addition, the light transmitting cover 191 may be given diffusibility with respect to light emitted from the light source 170.

A decorative frame 195 is provided below the light transmitting cover 191 (opposite side of the reflector 180). The decorative frame 195 functions as an orientation control member for reflection, diffusion, blocking and the like of light emitted from the light source 170 and provides appearance and design characteristics to the lighting device 150.

A lighting device 206 is provided on a lighting unit attachment portion 155 provided extending from the light source accommodation portion 153. The lighting device 206 includes a circuit board and various components mounted on the circuit board.

At the tip portion of the lighting unit attachment portion 155, a terminal block attachment plate 207 is provided, and a terminal block 203 is attached to the lower surface of the terminal block attachment plate 207. The upper side of the lighting device 206 and the terminal block 203 are covered by a cover 205.

The lighting device 206 converts alternating current from a commercial power source to direct current and outputs the current to the light source 170, and controls the lighting of the light emitting element 172. An incoming wiring from a commercial power source (power source wire, ground wire) wired behind the ceiling or a control signal wire such as a light adjustment signal wire or the like wired behind the ceiling is connected to the terminal block 203.

The terminal block 203 is connected to the lighting device 206 via an internal electrical wire (not shown). The lighting device 206 is electrically connected to the light source 170 and the terminal block 207, and controls the lighting state of the light emitting element 172 based on the control signal input via the control signal wire connected to the terminal block 203 from the outside, and provides lighting power supplied via the power supply wire connected to the terminal block 203 from the outside to the light emitting element 172.

Plural (for example, 3) attachment springs 201 are attached to the outer wall of the decorative frame 195. The attachment springs 201 are plate springs, and the lighting device 150 according to the second embodiment uses the elasticity of the attachment springs 201 and is attached to the recessed hole provided in the ceiling.

Light emitted from the light source 170 has a desired orientation via the reflecting plate 180, light transmitting cover 191 and the decorative frame 195, and is emitted toward a space below the ceiling.

According to the second embodiment, the reflector 180 provided between the light source 170 and the light transmitting cover 191 allows the light emitting surface (phosphor layer 173) of the light source 170 to be exposed with respect to the space between the light source 170 and the light transmitting cover 191 and covers and hides most of the region outside the mounting region of the light emitting element 172 on the substrate 171 and the majority of the connector 174.

A part of the light emitted from the light source 170 returns to the substrate 171 side by reflecting on the reflector 180 and light transmitting cover 191. Here, the substrate surface may have reflectivity through being white using a resist or silk, or making the substrate material a highly reflective material. However, the resist or resin used in the substrate 171 has low reflectivity when compared to a highly reflective resin material used in the reflector 180 and deteriorates easily. In addition, even in the connector 174 which is a resin component, reflected light returning to the substrate 171 side is irradiated, and there is concern of the connector 174 deteriorating.

According to the second embodiment, the resin parts of the majority of the region outside the light emitting surface (including the connector 174) of the light source 170 are covered and hidden by the reflector 180. Therefore, reflectivity rises in the light extraction direction, reliability improves by blocking the light which is a cause of deterioration of resin components such as the connector 174, and device efficiency increases.

According to the above embodiments, since only a part of the light source is resin, even if a resin with good light resistance is used, the resin may be used in small quantities, and since other parts do not use resin, a lighting device with a long service life for the device as a whole may be provided while suppressing the usage amount of expensive resins with good light resistance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A lighting device comprising:
a main body formed from metal and including a light source attachment portion;
a light source including a substrate formed from ceramic and attached to the light source attachment portion of the main body, and a light emitting element mounted on the substrate;
a light transmitting cover formed from glass and provided opposed to the light source attachment portion; and
a reflector formed from metal, and held by the main body without contact with respect to the main body and the light source between the light source attachment portion and the light transmitting cover,
wherein, between the light source attachment portion and the light transmitting cover, parts irradiated with light emitted from the light emitting element do not include a resin, except for a part of the light source.

2. The device according to claim 1, wherein the light source includes a resin layer covering the surface of the light emitting element as the part including resin.

3. The device according to claim 2, wherein a phosphor is dispersed in the resin layer.

4. The device according to claim 1, wherein the light source further includes a connector mounted on the substrate, electrically connected to the light emitting element, and formed from metal.

5. The device according to claim 1, wherein the substrate of the light source is fixed with respect to the light source attachment portion of the main body by a metal spring member.

6. The device according to claim 1, wherein the main body is grounded and the reflector is electrically floating.

7. The device according to claim 1, wherein the reflector includes a reflecting surface expanding and opening from a light opening formed on the light source side toward a floodlight opening formed on the light transmitting cover side.

8. A lighting device comprising:
a main body formed from metal and including a light source attachment portion;
a light source including a substrate on which a wiring pattern is formed and attached to the light source attachment portion of the main body, a light emitting element mounted on the substrate, and a connector formed from a resin, mounted on the substrate, and electrically connected to the light emitting element through the wiring pattern;
a light transmitting cover provided opposing the light attachment portion, and
a reflector provided between the light source attachment portion and the light transmitting cover, exposing a light emitting surface of the light source with respect to a space between the light source and the light transmitting cover, and covering and hiding a region outside a mounting region of the light emitting element in the substrate and the connector with respect to the space.

9. The device according to claim 8, wherein the connector is mounted on an outside of the mounting region of the light emitting element on the substrate, and
majority of the connector is covered and hidden by the reflector except a portion of the mounting region side of the light emitting element.

10. The device according to claim 8, wherein the light source further includes a phosphor layer covering a surface of the light emitting element.

11. The device according to claim 8, wherein the reflector is formed from a resin material having a higher reflectivity than the resin of the connector with respect to light emitted from the light source.

12. The device according to claim 8, wherein the reflector is formed in a ring-shape including a center hole in which the light emitting surface of the light source is exposed, and a connector shielding portion covering and hiding the connector is provided in a part of an inner peripheral portion of the center hole.

13. The device according to claim 12, wherein the center hole of the reflector is formed in the light source side, and functions as a light opening, and
a floodlight opening with an opening area larger than the light opening is formed on the opposite side to the light opening in the reflector.

14. The device according to claim 13, wherein the floodlight opening is covered by the light transmitting cover.

15. The device according to claim 13, wherein the reflector includes a reflecting surface expanding and opening toward the floodlight opening from the light opening.
